(19) United States
(12) Patent Application Publication
(10) Pub. No.: US 2008/0281826 A1
(43) Pub. Date: Nov. 13, 2008

(54) MANAGING POTENTIAL CLINICAL TRIAL PARTICIPANTS

(75) Inventors: Todd B. Sanders, Austin, TX (US); Lance D. Nickens, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: The Patient Recruiting Agency, LLC, Austin, TX (US)

(21) Appl. No.: 12/119,022

(22) Filed: May 12, 2008

Related U.S. Application Data
(60) Provisional application No. 60/928,696, filed on May 11, 2007.

(51) Int. Cl. G06F 17/30

(52) U.S. Cl. 707/9; 707/E17.107

(57) ABSTRACT

A method for managing information on potential participants in clinical research trials is disclosed. The method and system include populating a centralized secure database with information on a contact from the contact's response content or referral content, assigning investigative responsibility for the contact to an investigator, and providing the investigator access to the information of the contact through a secure web portal.

### CROSS-REFERENCE TO RELATED APPLICATIONS

This non-provisional application claims priority based upon prior U.S. Provisional Patent Application Ser. No. 60/928,696 filed May 11, 2007, entitled “A system and method of using internet web portals to distribute to clinical research investigators data and media collected centrally pertaining to potential participants in the trial (contacts) who may or may not be pre-screened, then providing contact management and scheduling tools for the investigator to use with the contacts,” the disclosure of which is incorporated herein by reference.

### BRIEF SUMMARY OF THE INVENTION

The present invention provides a system and method for managing potential participants in a clinical trial and, more particularly, for (1) distributing data pertaining to potential participants in clinical research trials that is collected centrally, and (2) providing a contact management and scheduling tool for the investigator to use with the data.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram depicting the flow of information through one embodiment of the present invention.

### DETAILED DESCRIPTION

The data will pertain to individuals (sometimes referred to as “contacts”) seeking to participate in the research trial. The contacts may or may not be screened or pre-screened. If they are screened, they are called “referrals.” If they are not screened, they are called “responders.” In one embodiment, the data is collected centrally through another system or systems that may or may not include human interaction.

Once the data is received in the central database, the information is used to determine to which person conducting the trial the information should be disseminated. The person conducting the trial is known as an “investigator.” The information is then flagged in the database to appear in only the appropriate investigator's portal. The data for each investigator is viewable through a secure web-portal protected by log in and password and encrypted protocols.

At the investigator portal, the information is displayed between active and non-active referrals and responders. Along with each contact will be other basic information about that referral, including a unique tracking number. The lists may be sorted by this information. Included in this information will be a particular status of that contract to reflect the effort to contact, schedule and enroll the contact into the study.

Additional information may be obtained about each contact by clicking on that contact, which additional information will include a full display of data pertaining to the contact including any media and including any screening or pre-screening information provided by that contact. At this individual contact page, the status of the contact may be updated, notes taken and the entire contact history viewed. Appointments made by the investigator may also be entered here.

Appointment scheduling information will be handled through another page, whether the appointments are scheduled by the investigator or centrally. The Investigator's appointments will be listed in a graphical format and standard format. If appointments are to be made centrally for the investigator, there will be an input section where the investigator indicates when appointment times are available or not available. This is also the page where the results of the appointment are recorded. This page may have a feature whereby once a scheduled appointment passes, the page pops-up upon log-in and before other pages may be viewed or action taken, all appointments must be updated with the results.

All personal data is then scrubbed from these records and reported to those running the clinical research trial along with the activity of the investigators. These reports are also made via a password protected encrypted link.

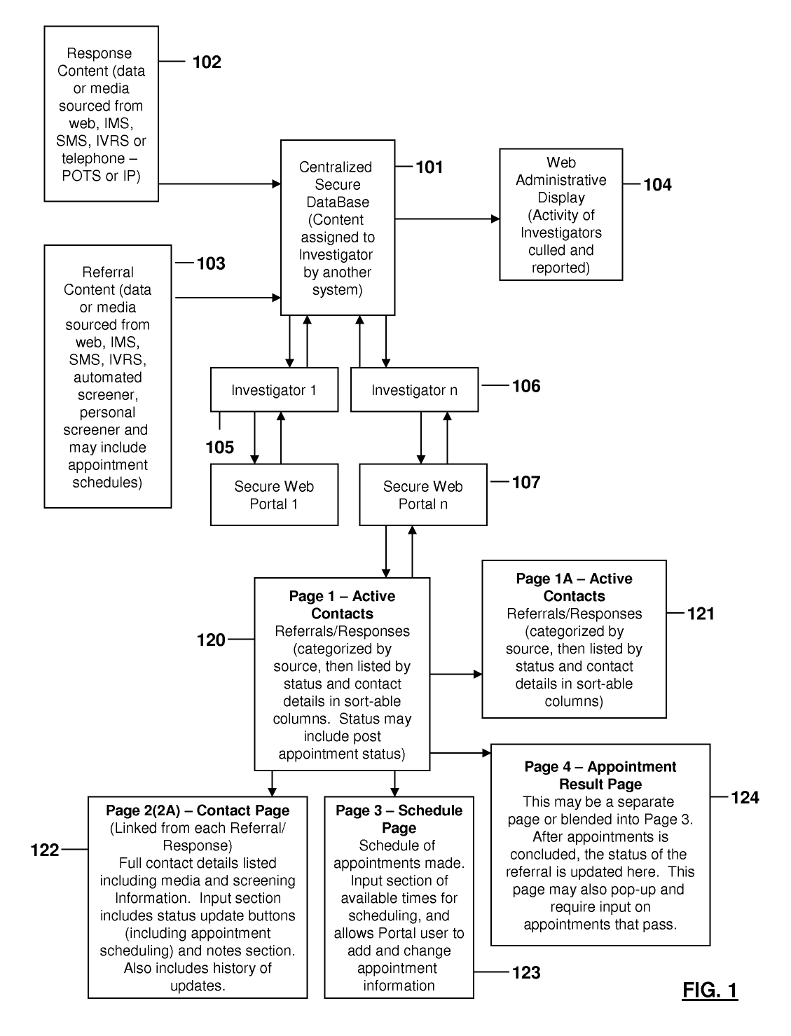

Referring now to FIG. 1, Centralized Secure Database 101 receives Information Response Content 102, which may include data or media sourced from the web, IMS, SMS, IVRS, or the telephone, either a plain old telephone system or a voiceover internet protocol system. In addition, the Centralized Secure Database 101 may receive information referral content, which may include data or media sourced from the web, IMS, SMS, IVRS, and automated screener, a personal screener, and such information may include appointment schedules. The information in the Centralized Secure Database 101 may be displayed through the Web Administrative Display 104 through which activity of investigators may be called and reported.

Information in the Centralized Secure Database 101 may be assigned to one or more investigators by methods that are known in the art. Referring again to FIG. 1, the content in the Centralized Secure Database 101 is assigned to one or more Investigators 105-106. Investigator may access information assigned to that Investigator through a Secure Web Portal 107.

Information in the Secure Web Portal 107 may include Active Contacts 120, which may include referrals or responses and which may be categorized by source than in some case listed by status in content details in sortable columns. In addition, the Active Contacts 120 information may include post appointment status. In addition, the Secure Web Portal may include Active Contacts 121, which again may include referrals or responses categorized by source and in certain cases listed by status in contact details in sortable columns.

In one embodiment, a Contact Page 122 is accessible through the Active Contacts 120. The Contact Page 122 may include a link from each referral or response as well as full contact details, including media and screening information. The Contact Page 122 may include an input section, which includes status update buttons (including appointment scheduling) and notes sections. It may also include a history of contact updates.

A Schedule Page 123 may also be accessible through Active Contacts 120. The Schedule Page 123 may include a schedule of appointments made, as well as an input section of available times for scheduling, which would allow portal users to add and change appointment information.

An Appointment Result Page 124 may also be accessible through Active Contacts 120. The Appointment Result Page 124 may be a separate page or may be integrated with Schedule Page 123. After an appointment is concluded, the status of the referral may be updated on the Appointment Result Page 124. This page may also be viewed in a pop-up manner.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Finally, in the foregoing discussion and in the claims, the terms “including” and “comprising” are used in an open-ended fashion, and thus should be interpreted to mean “including, but not limited to . . . ”.

What is claimed is:

1. A method for managing potential clinical trial participants comprising:
populating a centralized secure database with information on a contact from said contact's response content or referral content;
assigning investigative responsibility for said contact to an investigator;
providing said investigator access to said information of said contact through a secure web portal.

2. The method of claim 1 wherein information provided through said portal includes active contacts and inactive contacts.

3. The method of claim 1 wherein information provided through said portal includes active contacts and further includes a contact page, a schedule page and an appointment result page.

4. The method of claim 1 wherein information provided through said portal includes active contacts and inactive contacts.
